(19) United States
(12) Patent Application Publication
(10) Pub. No.: US 2005/0271221 A1
(43) Pub. Date: Dec. 8, 2005

(54) Airborne collection of acoustic data using an unmanned aerial vehicle

(75) Inventor: Stephen A. Cerwin, Mico, TX (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: Southwest Research Institute, San Antonio, TX (US)

(21) Appl. No.: 11/122,821

(22) Filed: May 5, 2005

Related U.S. Application Data
(60) Provisional application No. 60/568,399, filed on May 5, 2004.

(51) Int. Cl. H04R 1/02; H04R 3/00

(52) U.S. Cl. 381/92; 381/122; 381/91

(57) ABSTRACT

An acoustic data collection system that uses an antenna array aboard a powered unmanned and remotely controlled parafoil. The antenna array has multiple microphone elements, whose outputs are combined to provide directionality to the data acquisition.

### RELATED APPLICATION

This application claims priority to U.S. provisional patent application No. 60/568,399, entitled “Airborne Collection of Acoustic Data Using an Unmanned Aerial Vehicle,” filed on May 5, 2004, the full disclosures of which is incorporated herein by reference.

### TECHNICAL FIELD OF THE INVENTION

This invention relates to surveillance systems, and more particularly to a mobile acoustic data collection system that uses an antenna array aboard an unmanned aerial vehicle (UAV).

### BACKGROUND OF THE INVENTION

There has been increasing interest in the military, security, and law enforcement communities to collect acoustic data from airborne platforms, and particularly from unmanned aerial vehicles (UAV's). An airborne platform offers the significant advantage over ground-based sensing of mobility: the ability to be deployed remotely and to quickly and easily cover large areas. This capability would allow the military to acquire remote battlefield intelligence from a safe standoff distance and offers a unique data collection tool for security specialists.

Many types of data can be obtained from an airborne platform. One example is information on emitters through acoustic direction finding. Also, signature data that can be used to identify vehicles and machinery through spectral analysis. Typical applications include location of gunfire and target identification.

The use of UAV platforms for remote acoustic data collection, presents two difficult challenges. One challenge is interference from engine noise. Fuel-burning engines generate noise from exhaust gases, vibration, and from the propeller. The amplitude of these sounds is many times greater than that of the desired signals and therefore poses a serious limit to sensitivity. The engine vibrations that shake the entire airframe and the noise generated by the propeller arc are physically extended sources and thus do not lend themselves well to reduction by adaptive signal processing. Electric powered UAV's can solve this problem because they can shut the engine down for data collection and then reliably restart to continue flight. However, electric powered UAV's suffer from relatively short endurance times compared to gas powered platforms. Although shutting a gas engine down for data collection is an option, the engines on most small UAV's are difficult to start when hot and require a large and heavy battery for the starter. Thus an air restart of a gas engine on a small UAV is problematic.

The second challenge is wind noise. Wind noise exhibits approximately a 1/f frequency characteristic that increases in amplitude with the square of velocity. At the speeds used by most UAV's, wind noise also tends to be louder than the desired target sounds (except perhaps nearby gunfire). Wind noise can be reduced by the proper design of wind screens, judicious placement on the airframe to take advantage quiet regions in the airflow, and by averaging techniques. Having done all of the above, the wind noise that remains, though reduced, still exhibits a velocity-squared dependency.

### BRIEF DESCRIPTION OF THE DRAWINGS

FIG. 1 illustrates a parafoil UAV equipped with a microphone array and data processing unit in accordance with the invention.

FIG. 2 illustrates the UAV of FIG. 1, without its sail, and presents a better view of its microphone array.

FIG. 3 illustrates the data acquisition procedure and flight profile of a typical acoustic data collection flight of a UAV in accordance with invention.

FIG. 4 illustrates an example of a two-dimensional “soundfield” output provided by a computer used to process acoustic data collected by the UAV.

FIG. 5 is an example of a time domain data record from one microphone during a UAV data collection flight.

FIG. 6 is a “waterfall plot”, which represents single-axis beam-formed data obtained from a UAV while in flight over a target vehicle.

### DETAILED DESCRIPTION OF THE INVENTION

The following description is directed to acoustic data collection from a UAV (unmanned airborne vehicle). The systems and methods described herein address the issues of both engine noise and wind noises. Two features of the invention are the use of a multi-element microphone array for the acoustic sensor, and the use of an appropriately designed and operated UAV platform.

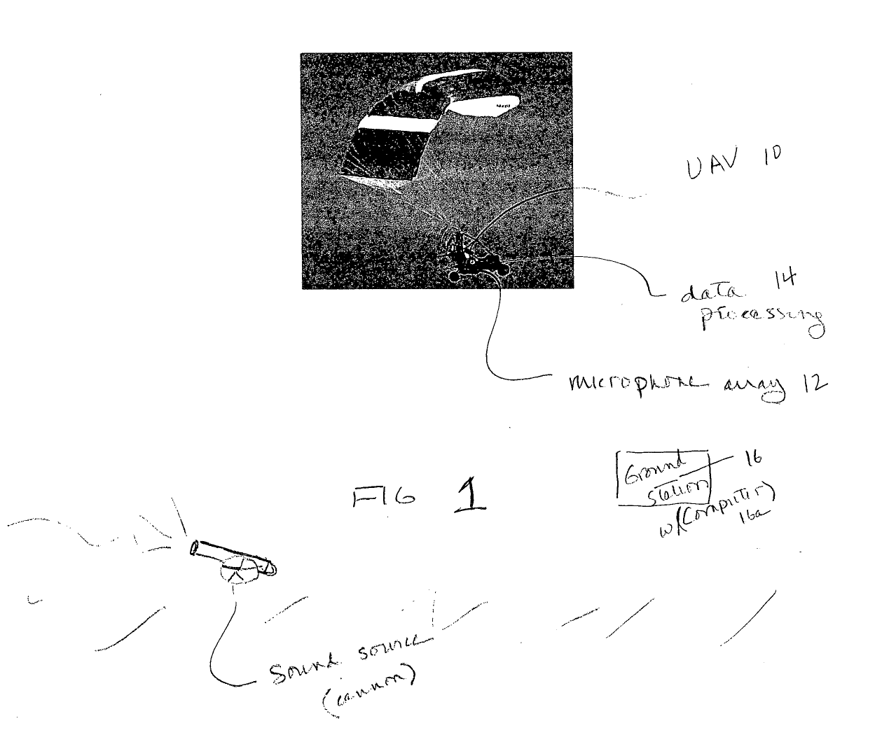

FIG. 1 illustrates a UAV 10 equipped with an acoustic data collection system in accordance with the invention. In the example of FIG. 1, UAV 10 is a parafoil, but as explained below, other types of UAVs may be used. System 12 detects and locates ground-based acoustic sources, such as gunfire and vehicle noise.

The airborne components of the data collection system comprise a microphone array 12 and a data processing unit 14. Microphone array 12 consists of multiple acoustic sensing elements (“microphones”) on at least one axis, with preferably more than eight microphones per axis. Data processing unit 14 has at least a transmitter for transmitting acoustic response signals (or data) to a ground station 16. Depending on the distribution of on-board versus remote data processing, data processing unit 14 may alternatively comprise a 16-channel data recorder and other analog or digital signal processing devices.

Where data processing unit 14 transmit signals or data to ground station 16, station 16 has a receiver and digitizer or data reader and a data acquisition and display computer 16a. In other embodiments, some or all of the ground-based components may be placed on-board the UAV 10. The ground station 16 may be in the presence of the UAV operator (not shown) or remote from the UAV operator or the UAV flight path. The “ground” station could also be airborne in another air or space vehicle. Furthermore, in different embodiments of the invention, the UAV operator may fly the UAV by sight or by remote instrumentation means.

Raw or processed audio data is available as an output from data processing unit 14. For example, as explained below, data from microphone array 12 may be processed to form a two-dimensional sound field plot showing the elevation and azimuth angles to detected sound sources relative to the pitch and bank attitude of the UAV 10.

Microphone Arrays

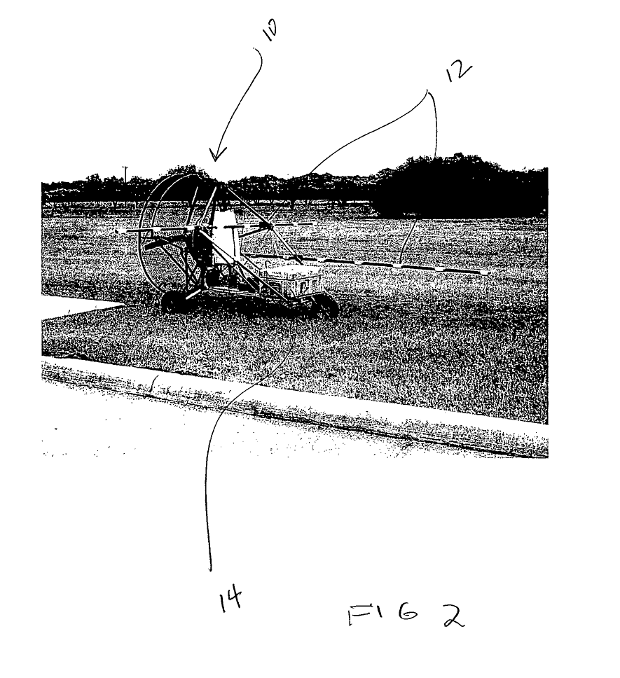

FIG. 2 illustrates parafoil UAV 10 without its sail, and further illustrates microphone array 12. In the embodiment of FIG. 2, the crosswise array 12 consists of two axes. One axis has 8 microphones along the wing. Another axis has 8 microphones along the fuselage. Examples of suitable microphone spacings along an axis are spacings on 6, 12, or 24-inch centers. As an alternative to the externally placed microphones of FIG. 2, the microphones could be integrated into wing and fuselage structures.

The multiple microphones are used to form a directional beam on an acoustic emitter (“the target”). The beam represents a direction vector from the array to the target.

More specifically, the outputs of the microphone array 12 can be combined by appropriate signal processing to form a directional beam in much the same way as the electromagnetic counterpart of a phased array antenna. Multiple signal processing techniques exist (e.g., delay and sum, CSP, MUSIC, etc.) and can be used to process array data.

The beam provides directionality (also referred to as directivity) in the sense that it provides the ability to listen in one direction and not another. By adjusting the delay times of individual microphone elements with computer 16a, the beam can be steered electronically to any compound angle over an entire hemisphere. This ability to form a beam on a target yields enhanced signature recognition by eliminating interference from other sources. It also yields the angular location of ground and air sound sources, referenced to the UAV's airframe.

The multiple microphone elements of array 12 also provide wind noise averaging, resulting in an improvement in signal-to-wind-noise ratio that scales with the square root of the number of microphones. More specifically, the signal strength of an emitter target in the beam scales directly with the number of microphones in the array 12. However, the wind noise is uncorrelated across the individual microphone apertures, so wind noise in the array output only increases as the square root of the number of microphones. Thus the signal-to-wind noise ratio improves with the square root of the number of microphones. Therefore large microphone arrays 12 with many elements are indicated for applications where wind noise abatement is paramount.

The aperture of the array 12 is preferably greater than one wavelength at the lowest frequency of interest for good directivity. Microphone spacing preferably should be a half wavelength or less at the highest frequency of interest to prevent the formation of unwanted grating lobes.

The performance of the microphone array 12 is dependent upon the size of the array in terms of wavelength, and thus is frequency dependent. To form effective beams (beam widths less than 20 degrees or so), the array should be several wavelengths long. Because the frequencies of interest to signature recognition of many vehicles are low (20 to 500 HZ), an effective array would have to be relatively long (ten feet or more). This poses a requirement on the UAV airframe that is solved by the relatively large aperture afforded by a parafoil.

A single linear array can be processed to give the direction vector to an emitter in one axis. A two-axis array such as the array 12 of FIG. 2 achieves directivity in both axes. A two-axis array may take the form of two orthogonal linear arrays (as in FIG. 2), an X-Y rectilinear matrix, or a circularly disposed array with one or more concentric circular arrays.

The two-axis array 12 of FIG. 2, composed of two orthogonal linear axes, provides the solid angle from the UAV 10 to an acoustic target in both axes. Thus the altitude and attitude vectors of the UAV (heading, pitch and bank) along with topographical map data can be combined with the acoustic data to mark the position of the target emitter on the ground.

Obtaining good data while in powered flight on the characteristically low frequency signatures associated with engine noise is difficult. Lower frequencies give the richest signature data, but wind noise worsens with decreasing frequency, providing a masking effect. Large microphone arrays help in two ways: by wind noise averaging effected by the large number of microphones and by providing superior directivity at low frequencies.

The beam width of a steered array is set by the physical size of the array in terms of wavelength. Larger arrays can produce narrower beam widths at lower frequencies. As the size of an array becomes smaller compared to a wavelength, the beam width broadens.

A second important parameter in designing microphone array 12 is population density. An array 12 becomes underpopulated at frequencies above the point at which microphone spacing is greater than about a half wavelength. Under these conditions, grating lobes occur. Grating lobes are full-strength aliases of the signal appearing at extraneous angles.

A well-designed microphone array 12 will have sufficient physical aperture for the desired low frequency beam width and sufficient population density to avoid high frequency grating lobes. Overpopulation does not affect the pattern and improves wind noise averaging.

Reduction of Wind and Engine Noise

One means for mitigating wind noise is to fly the UAV 10 as slowly as possible. Ideally, this is at minimum controllable airspeed (Vmc) and should be below 20 kts.

Another means for mitigating wind noise is to place the microphone array 12 at acoustically quiet locations on the airframe of UAV 10. Examples of such locations are areas of smooth laminar airflow, in airflow shadows, and out of turbulent regions near discontinuities that cause parasite drag.

A third means for mitigating wind noise is to use an effective wind screen design. Typical noise reduction design features are airfoil or other low-drag shapes and an appropriate acoustic baffle design.

A fourth means for mitigating wind noise is to use frequency shaping in the microphone preamplifiers to preserve dynamic range.

A fifth means for mitigating wind noise is to use many microphones in the array 12. Beam-formed acoustic signals increase directly with the number (N) of microphones in the array. In contrast, uncorrelated wind noise increases only as the square root of N. Thus the signal to wind noise ratio improves with the square root of the number of microphones in the array.

Significantly increasing the number of data channels to add more wind noise averaging is difficult and expensive in term of bandwidth and complexity. One solution is to process the data on board the UAV and downlink only one or two (stereo) channels of beam formed data. An advantage of this approach is that a single video transmitter with stereo audio capability could be used for the complete real time video and audio data package. The UAV would have to be capable of flying a suitable computer and have enough wingspan to accommodate a large microphone array, placing a lower limit on UAV size. Software would have to be developed to automatically beam form on targets within the sound field. The two dimensional sound field plots have already computed the direction vectors so automatic beam forming is just a matter of applying them to a beam forming algorithm. In the event of multiple targets, commands from the ground or a scanning algorithm could be used to scan between the targets.

Another approach to reducing the processing burden of many channels is to perform at least some of the beam steering in the analog world. Op-amp based delay-and-sum circuits exist to steer the beam of a microphone array. This would relieve the requirement on the computer system to import, digitize, and process a large number of channels. Such a hybrid system could offer real advantages in overall system size and power requirements.

Also, the array aperture can be minimized. Smaller arrays have larger beam widths and therefore do not have as critical a steering requirement. As an example, additional wind noise averaging could be added by increasing breadth instead of width. If an 8-station array were mounted beneath the wing, the total number of microphones could be increased by summing additional microphones located down the wing chord at each station. Thus the wind noise performance of each station would be improved, producing a comparable result in the beam formed output. This concept could be expanded even further. A small array with many elements (e.g., a 128-element, 8×16 rectangular array with microphones on M to 1 inch centers) would give significant wind noise averaging while having a beam width so broad as not to require steering. Placing one such array under each wing would give enhanced stereo listening with only two down link channels. Direction vectors could be obtained by means other than beam forming, such as null-steering.

With regard to wind noise, the requirement for low airspeeds cannot be overstated. While it is true that wind noise can be mitigated by increasing the number of microphones in a steered array 12, the fact that wind noise increases as V-squared and wind noise averaging increases only as the square root of N means that the number of microphones required to normalize wind noise increases with the fourth power of airspeed. Thus a factor of two increase in airspeed would require a sixteen times increase in the number of microphones to get the same signal to wind noise ratio.

Engine noise can be handled simply by choosing a UAV 10 that is capable of stopping and restarting its engine while in flight. Electric powered UAVs possess this capability naturally. Gasoline-powered parafoil UAVs have also demonstrated reliable and immediate air restarts.

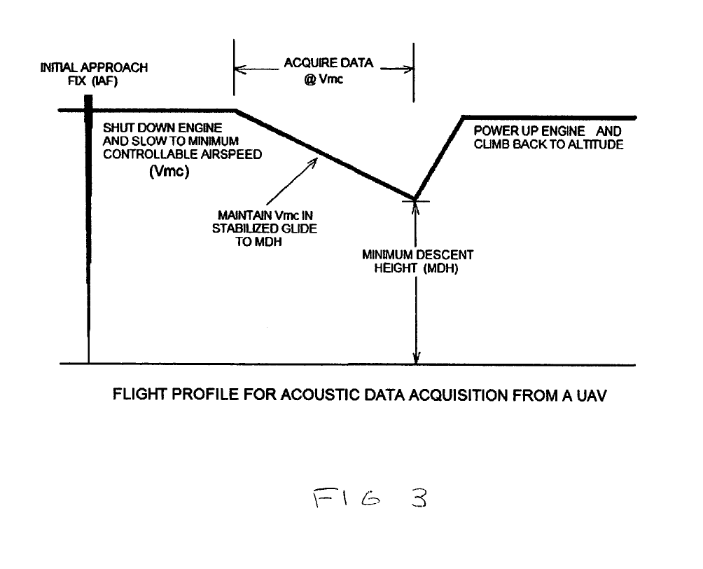

FIG. 3 illustrates the data acquisition procedure and flight profile of a typical acoustic data collection flight of UAV 10. The UAV is flown to an initial approach fix, the engine is shut down, the UAV is slowed to minimum controllable airspeed, a stabilized glide is established, and data is collected in the glide. When the minimum descent height is reached, the engine is restarted and the process is repeated as necessary.

UAV Platforms

To be effective for airborne acoustic data collection, UAV 10 should possess four characteristics:
1) it must be capable of deployment from the launch site to a remote target area with sufficient endurance to accomplish the mission, 2) it must be capable of slow flight over the target to reduce wind noise, 3) it must be capable of eliminating engine noise, and 4) it must have sufficient physical aperture to support an effective array at the lowest frequency of interest.

A powered parafoil UAV possesses all four of the desired characteristics. It has sufficient navigational authority to maneuver in moderate winds, it can shut off the engine and glide at slow airspeeds, it can carry a sufficiently large payload to use a gas engine capable of long range flights and reliable air restarts, and it has the additional advantage of affording a large acoustic aperture. Also, it can sustain extended periods of unpowered flight to allow quiet acoustic data collection with the engine shut down. The parafoil UAV has a large payload capability to carry an engine capable of reliable air restarts. It is capable of the slow flight required to reduce wind noise to the levels required for high quality acoustic collection. It has the power and navigational authority to be deployed to a specified remote site for data collection in moderate winds. It can carry sufficient fuel for long-range and long-endurance missions.

The canopy of a powered parafoil typically is much larger than the wingspan and fuselage length of an airplane type UAV. The large canopy provides a large acoustic capture area suitable for mounting the large microphone arrays necessary for good directivity at the low frequencies associated with the noises emitted by airplanes, helicopters, ground vehicles, machinery, and gunfire.

The large aperture is ideal for large arrays that can provide excellent directionality and signature quality for the low acoustic frequencies associated with engine, vehicle, and industrial machine noises. The canopy also can be folded into a compact and rugged volume for ground transport.

Another potential UAVs platform is gas powered UAV's, which are capable of long-range deployments, but fly fast and do not tend to have reliable airborne engine restarts. Additionally, their wingspans are marginally long enough to support a microphone array effective at low frequencies.

Electric powered gliders can reliably stop and start the engine, are capable of sufficiently slow flight. They can have large wingspans for improved acoustic apertures.

Additional possibilities exist for the collection of airborne acoustic data. In an ideal situation, air-flow over the microphones would be reduced to zero. Except for momentary periods in a deep stall, no airplane or parafoil can accomplish this. But a balloon can. One possible data collection scenario is to deploy several balloon supported aerosondes over an area from a passing manned or unmanned airplane, in the manner sonobuoys are deployed in the ocean. The balloons could auto inflate after release or descent to a target altitude and then float in the prevailing air mass at zero relative velocity.

### Experimental UAV Embodiments

In accordance with the above-described concepts, various UAV platforms have been adapted for airborne acoustic data collection and have been experimentally tested. These include gas-powered and electric-powered radio controlled (RC) airplanes and a large powered parafoil UAV. The different platform sizes afforded a study of applicable array physics including the effects of array aperture and population density.

Referring again to the general depiction of FIG. 1, in each test embodiment, the microphone array 12 contained 16 microphones, configured as two orthogonal 8-element arrays. The test UAV's and their arrays were constructed in three sizes: a 3-½ foot array with 6″ spacing mounted on an electric powered RC glider, a 7 foot array with 12″ spacing mounted on a large RC airplane, and a 14-foot array with 24″ spacing mounted on a large autonomous gas-powered parafoil. The design frequencies were 800-1000 Hz, 400-500 Hz, and 176-275 Hz, respectively. These arrays provided identical beam widths in successively lower frequency octaves. A commonality to all test UAVs was the capability for slow, unpowered flight.

For the electric-powered glider UAV, one of the two orthogonal 8-element axes of the microphone array was mounted in airfoil-shaped pods under the wing. The other axis was mounted in a side bar attached along the fuselage. A synchronous 16-channel RF transmitter was mounted above the wing, and was used to downlink sensed data in real time to a ground station.

After climbing to altitude the electric glider was flown over the target vehicles at a variety of altitudes, approach angles, and lateral separations. When the UAV was in position, the engine was shut off and the UAV was established in a stabilized glide at minimum controllable airspeed. The command to begin recording then was relayed to the ground station via handheld radio. Sorties were held to 10-15 minutes duration, but longer flights are possible. The glider's clean airframe penetrated the wind well, and was capable of stable flight at airspeeds of less than 18 kts. With sufficient wind, sufficient wind lift can permit the glider to hover over a target.

The gas-powered RC airplane was outfitted with an array twice the size of the electric glider array. It was successfully flight-tested and airborne data was recorded using a gasoline generator as an acoustic test target. Because it did not have an air-restart capability, data acquisition entailed flying to the target area, killing the engine, and taking data over the target while in a glide to a dead stick landing.

For the parafoil, the microphone array 12 consisted of two orthogonal eight-element microphone arrays with a 24″ spacing between microphones. The large aperture was intended to provide narrow beam widths at the low frequencies anticipated for vehicle sounds. The engine was shut down for data collection and then restarted to continue the flight. Special foam shields were included over each microphone station for wind noise reduction.

Both the RC airplane and the parafoil used on-board data storage rather than real time downlink to a ground station. Data processing featured simultaneous sampling of sixteen input channels and storage on a flash memory card of the type used in modern digital cameras. A 1-Gb flash card could store 48 minutes of continuous recording. Operationally, the recorder was started prior to takeoff and ran the entire duration of the flight.

Like the glider, data collection with the parafoil involved repeated engine-off glides over the target area, airborne restarts, and climbs back to altitude. Data runs began at 1000-ft and ended when the parafoil descended to 400-ft. Although capable of 3-hour flights, sorties were held to 45 minutes.

To test the three test UAV's under identical conditions, all three UAV's were taken to the same ground site. Acoustic data was collected while target vehicles passed by some distance away. The range to the target vehicles was approximately 100 meters. Since simultaneous flight of all three UAV's over the same target at the same time was impractical, this ground-based measurement provided a test setup to directly compare the responses of the three arrays.

Waterfall plots were generated of the measured array responses to a test vehicle as it passed in front of the arrays. These plots depicted the farfield soundfield expressed as angle to target versus time. Both angle to target and effective beamwidth can be derived from this representation. The three arrays provided identical beam widths even though they came from arrays successively doubling in size and were processed in successively lower frequency octaves.

As the size of the microphone array 12 becomes smaller compared to a wavelength, the beam width broadens. To test this concept, theoretical and measured response patterns of the 6-inch array beam were formed at 250 Hz, two octaves below the design frequency. Both the predicted and measured data exhibited the same beam broadening as compared to the design frequency.

Instrumentation and Data Processing

Referring again to FIGS. 1 and 2, UAV 10 is equipped with an n-channel audio data recorder 14, which may be on-board or at a remote station, such as ground station 16. Computer 16a can store the n-channel data directly to disk for archive and post processing. Operation can be either live (real-time), from previously stored files, or from memory used with the n-channel data recorder.

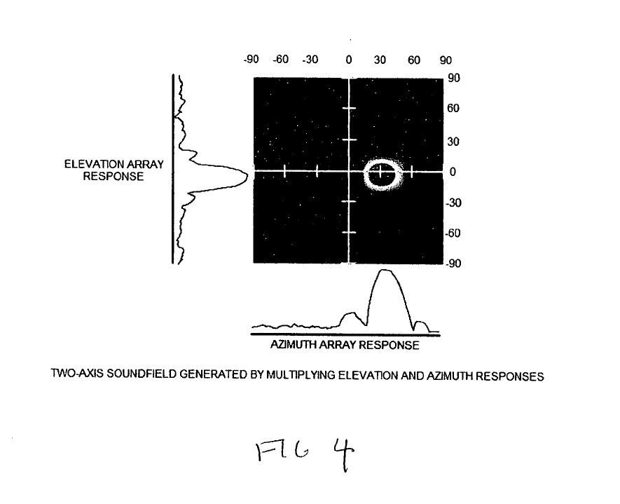

FIG. 4 illustrates an example of a two-dimensional “soundfield” output provided by computer 16. The soundfield is generated by multiplying elevation and azimuth responses. The azimuth and elevation angles to the target are mapped to X and Y on the display. Amplitude may be mapped to display color.

An example of suitable data processing software for computer 16 is the Signalscape® two-axis array processing software available from Signalscape, Inc. The sound field graph updates in real time at 11 fps and automatically selects the loudest source for display.

Experimental flights using the above-described parafoil embodiment of UAV 10 captured acoustic data with a 16-channel audio recorder that used a flash memory card for data storage. Data was taken simply by starting the recording immediately prior to takeoff and letting the recorder run continuously during the flight. The acoustic targets were land vehicles in operation 400-1000 feet below the flight path.

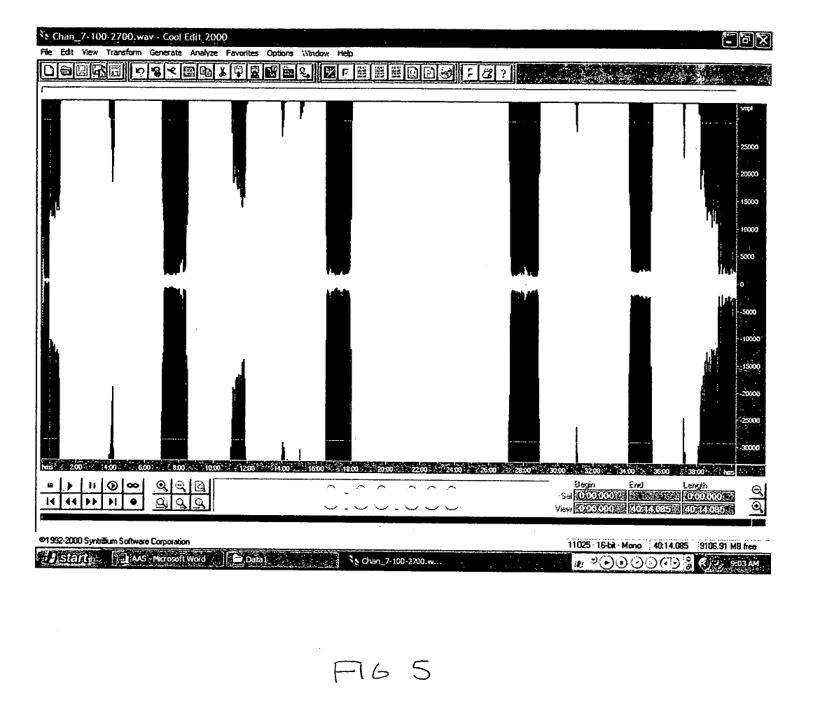

FIG. 5 is an example of a time domain data record from one microphone on one of the parafoil UAV flights. The large full-scale signals are from the UAV engine while the engine was running. There is a quiet region at the beginning prior to engine start and at the end after landing and engine stop. Four engine-off “data pass” recordings can be seen in the middle. The momentary peaks within the data recordings are sounds from the target vehicles. With the wind screens used and at the speeds flown, the vehicle sounds exhibited approximately 6 to 10 dB SNR on this microphone. Array beam forming can improve the SNR by 3 dB each time the number of microphones is doubled, or by up to 12 dB for a 16-element array.

By zooming in on the data pass regions, vehicle sounds can be detected. In these regions, surges in the envelope amplitude are from engine sounds on the test vehicles. When listening to some of the recordings, the sounds of the vehicles shifting gears could be heard. A spectral analysis of the data pass regions showed that target sounds peaked above the wind noise midrange in frequency, that is, from 1500 to 2500 Hz. This suggests preferred frequency ranges in the presence of wind noise. Even though the target signature contains ample signature data below 500 Hz, wind noise can obliterate it. In the presence of wind noise, better signature data can often be had above 500 Hz than below.

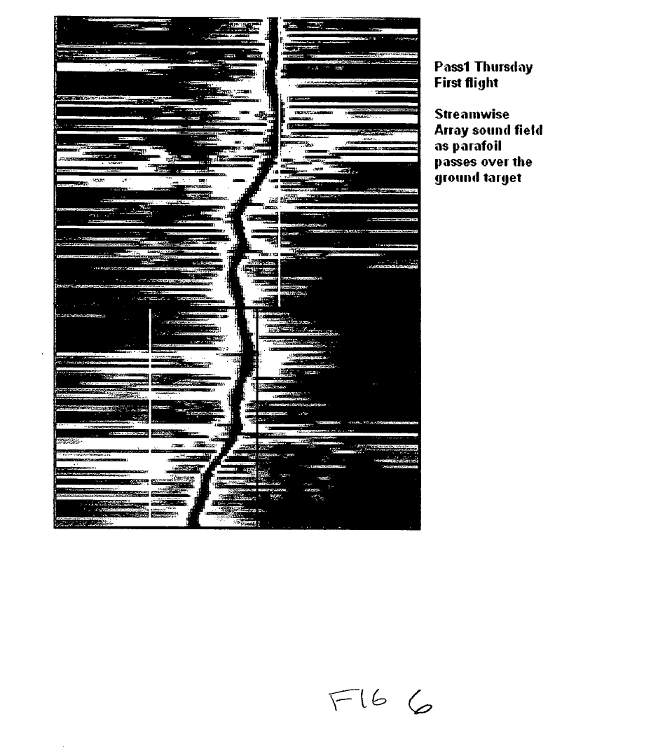

FIG. 6 is a “waterfall plot”, which represents single-axis beam-formed data obtained from the parafoil UAV 10 while in flight over the target vehicle. The data is from the streamwise (longitudinal) axis of microphone array 12. The meandering stripe depicts the angle from the microphone axis to the target vehicle versus time. Total angular range is +/−90 degrees, with zero (straight down) represented in the center. The gradual right to left drift represents relative motion between the parafoil and the target vehicle.

Referring again to FIG. 4, the two-dimensional sound field plot can be obtained by cross-correlating the beam-formed data from both the longitudinal and transverse microphone axes of array 12. The position of the middle spot depicts the elevation and azimuth angles to the target. A straight-ahead direction is at the top of the graph, straight-behind at the bottom, and right and left on either side. If the exact location, altitude, and pitch and bank attitudes of the microphone array are known, data such as the data of FIG. 4 can be used to locate a target on a topographical map.

In sum, for the parafoil UAV 10, the large microphone array 12 provided expected improvements in directivity at low acoustic frequencies. As evidenced in the waterfall data illustrated above, the beam width of the acoustic array gave excellent spatial resolution on ground target position. However, signature quality for frequencies below 500 Hz was not realized because of the aggressive 1/f nature of wind noise. In analyzing the spectral content of the data, it was found that the signatures from the running vehicles peaked up above the wind noise at frequencies above 500 Hz but were obliterated below. For a running vehicle on the ground and from a UAV flying in the presence of wind, better target data was obtained above 500 Hz than below. Listening deeper into the low frequency spectra would require more elements in the array, better wind screen designs, and/or slower flight speeds.

Experimental flights were also performed using the above-described glider embodiment of UAV 10. A waterfall plot of vehicle noise, under conditions similar to that of FIG. 6, provided a wider beam due to the difference in physical aperture. During various flights, the array of targets included helicopters, other planes in flight, small gas engines, ground vehicles, car horns, gun shots and gun shot simulants, and shouted voices.

Data acquired during glider UAV flights suggests that excellent data may be obtained even with microphone arrays of modest physical aperture. In particular, the 42-inch microphone axis length used on the glider, though not capable of forming as tight a beam width at low frequencies as the 14-foot axis of the parafoil, may well provide adequate directionality for various target types of interest.

The data from the glider UAV was better in quality than that from the parafoil UAV because the glider could fly more slowly. Even though the microphone array of the parafoil had four times the physical aperture, the arrays had the same number of microphones and thus had the same amount of wind noise averaging. While it was true that the smaller glider array could not produce the narrow beam widths of the parafoil array, the beam width it did produce was sufficient at the frequencies used. Unless there is a requirement to resolve multiple targets clustered in a small area, very tight beam widths may not be required. The importance of flying slowly and quietly may outweigh the advantage of a narrow beam width.

### SUMMARY

The invention described herein addresses collection of acoustic data from a self-contained airborne UAV while in flight. The UAV is capable of self contained operation, collecting acoustic data while in flight. A microphone array and array beam forming permits electronically steerable directivity to provide enhanced acoustic quality and to obtain the direction vector to an acoustic emitter from the UAV. The microphone array may be extended in more than one axis to provide a three dimensional solid angle from the UAV to the emitter. Noise reduction may be achieved in various ways, including selection of a UAV platform capable shutting down the engine for quiet data collection followed by reliable restart for continued flight. Wind noise can be mitigated by selecting a UAV platform capable of very slow flight in a gliding mode and by using many microphone elements to effect wind noise averaging proportional to the square root of the number of microphones.

The microphone array is designed to have a large physical aperture to be effective in beam forming the low frequencies required for vehicle signature recognition. The UAV platform can be designed to provide this aperture, as well as the range, endurance, and navigational authority to accomplish deployment from a launch point to a specified remote data collection area in moderate wind conditions. Collected data may be sent to a ground station in real-time via a radio link. Alternatively, on-board electronic data storage and/or processing can provide post processing and extended flight beyond radio range or in areas undergoing strong electronic jamming.

1. A system for collecting acoustic data from an acoustic target using an unmanned aerial vehicle (UAV), comprising:
a microphone array installed on the UAV, the array having a plurality of microphones; and
a data processing device for combining outputs of the microphones to form at least one direction vector representing a direction from the target to the UAV.

2. The system of claim 1, wherein the microphone array has more than one axis.

3. The system of claim 1, wherein the microphone array has two orthogonally placed axes.

4. The system of claim 1, wherein the array is an X-Y rectilinear matrix array.

5. The system of claim 1, wherein the array is a circular array.

6. The system of claim 1, wherein the processing device is operable to steer the beam by adjusting delay times from microphone elements of the array.

7. The system of claim 1, wherein the processing device is further operable to provide wind noise averaging of data provided by microphone elements of the array.

8. The system of claim 1, wherein the target has a frequency range of interest, and wherein the aperture of the array is greater than one wavelength of the lowest frequency of interest.

9. The system of claim 1, wherein the target has a frequency range of interest, and wherein the spacing of microphone elements of the array is less than one-half wavelength of the highest frequency of interest.

10. The system of claim 1, further comprising an analog beam steering circuitry.

11. The system of claim 1, wherein the direction vector is formed by beam-forming from the array output.

12. The system of claim 1, wherein the direction vector is formed by null-steering.

13. A method for collecting acoustic data from an acoustic target using an unmanned aerial vehicle (UAV), comprising:
collecting acoustic data from a microphone array on the UAV during flight of the UAV, the array having a plurality of microphones; and
combining outputs of the microphones to form at least one direction vector representing a direction from the target to the UAV.

14. The method of claim 13, wherein the microphone array has more than one axis.

15. The method of claim 13, further comprising steering the beam by adjusting delay times from microphone elements of the array.

16. The method of claim 13, further comprising averaging wind noise from the data provided by microphone elements of the array.

17. The method of claim 13, further comprising steering the beam using analog beam steering circuitry.

18. The method of claim 13, wherein the direction vector is formed by beam-forming from the array output.

19. The method of claim 13, wherein the direction vector is formed by null-steering.

20. The method of claim 13, comprising collecting acoustic data during engine-off operation of the UAV.
